(19) United States
(12) Patent Application Publication
(10) Pub. No.: US 2019/0171406 A1
(43) Pub. Date: Jun. 6, 2019

(54) INFORMATION PROCESSING APPARATUS AND METHOD OF CONTROLLING THE SAME

(71) Applicant: CANON KABUSHIKI KAISHA, Tokyo (JP)

(72) Inventor: Kazuhiro Monden, Inagi-shi (JP)

(21) Appl. No.: 16/203,796

(22) Filed: Nov. 29, 2018

(30) Foreign Application Priority Data
Dec. 1, 2017 (JP) 2017-231928

(51) Int. Cl. G06F 3/14; H04L 29/06; G09G 5/14

(52) U.S. Cl. CPC G06F 3/1454; H04L 65/1066; G09G 2360/04; G09G 2340/0407; G09G 5/14

(57) ABSTRACT

An information processing apparatus which displays a video image on a display unit, comprises a communication unit configured to communicate with a display apparatus via a network, and a control unit configured to generate a video image for an extended display on which the display apparatus displays when the communication unit establishes a connection with the display apparatus, the video image being different from the video image displayed on the display unit.

### BACKGROUND OF THE INVENTION

### Field of the Invention

The present invention relates to a system in which an information processing apparatus and a video image display apparatus are connected via a network.

### Description of the Related Art

A video image transfer system is known in which information processing apparatuses such as personal computers (“PCs” hereinafter) and video image display apparatuses such as projectors are connected via a network as opposed to a system in which PCs and projectors are connected via connection cables such as HDMI (r) cables. Such video image transfer systems are provided with functions such as the function of simultaneously causing a plurality of projectors to project a video image from a single PC and the function of causing a single projector to project video images from a plurality of PCs on multiple screens.

Japanese Patent Laid-Open No. 2014-127915 discloses a technology in which a work group is constructed from a plurality of PCs and a plurality of projectors, and the projectors display video images from the PCs in free layouts.

In a conventional system in which connection is made via video cables, when a PC and a projector are connected, the PC can automatically recognize the projector as an external display, and the desktop of the PC can be extended or replicated. In particular, when the desktop is extended, it is possible to treat the area recognized as an external display and spanning the display of the PC and the projector as a desktop area to work in. In this way, the display screen of the PC being used by the presenter may be different from the video image, which is projected by the projector, that the audience is viewing, as is widely practiced in presentations.

However, in a system in which a PC and a projector are connected via a network, as the PC is unable to automatically recognize the projector as an external display, the projector can only display the same video image as that on the display of the PC.

Moreover, if the desktop of the PC is to be extended or replicated, extension or replication needs to be performed at an appropriate timing because extending or replicating the desktop consumes PC resources.

### SUMMARY OF THE INVENTION

The present invention has been made in consideration of the aforementioned problems, and realizes a system capable of generating video images to be displayed on a device connected via a network at an appropriate timing.

In order to solve the aforementioned problems, the present invention provides an information processing apparatus which displays a video image on a display unit, comprising: a communication unit configured to communicate with a display apparatus via a network; and a control unit configured to generate a video image of an extended display to be displayed on the display apparatus displays when the communication unit establishes a connection with the display apparatus, the video image being different from the video image displayed on the display unit.

In order to solve the aforementioned problems, the present invention provides a method of controlling an information processing apparatus that includes a communication unit configured to communicate with a display apparatus via a network and display a video image on a display unit, the method comprising: generating a video image of an extended display to be displayed on the display apparatus displays when the communication unit establishes a connection with the display apparatus, the video image being different from the video image displayed on the display unit.

In order to solve the aforementioned problems, the present invention provides a non-transitory computer-readable storage medium storing a program for causing a computer to execute a method of controlling an information processing apparatus that includes a communication unit configured to communicate with a display apparatus via a network and display a video image on a display unit, the method comprising: generating a video image of an extended display to be displayed on the display apparatus displays when the communication unit establishes a connection with the display apparatus, the video image being different from the video image displayed on the display unit.

According to the present invention, it is possible to generate video images to be displayed on a device connected via a network at an appropriate timing.

Further features of the present invention will become apparent from the following description of exemplary embodiments (with reference to the attached drawings).

### BRIEF DESCRIPTION OF THE DRAWINGS

FIG. 1 is a diagram showing a system configuration according to an embodiment of the present invention.

FIG. 2 is a block diagram showing a configuration of the apparatuses according to the embodiment shown in FIG. 1.

FIG. 3 is a flowchart showing processing for generating an extended display according to the embodiment shown in FIG. 1.

FIG. 4 is a sequence diagram of the processing for generating an extended display according to the embodiment shown in FIG. 1.

FIGS. 5A-5L are diagrams illustrating UI screens according to the embodiment shown in FIG. 1.

FIGS. 6A-6C are diagrams showing alternative system configurations according to the embodiment shown in FIG. 1.

### DESCRIPTION OF THE EMBODIMENTS

Embodiments of the present invention will be described in detail below. The following embodiments are merely examples for practicing the present invention. The embodiments should he properly modified or changed depending on various conditions and the structure of an apparatus to which the present invention is applied. The present invention should not be limited to the following embodiments. Also, parts of the embodiments to be described later may he properly combined.

### First Embodiment

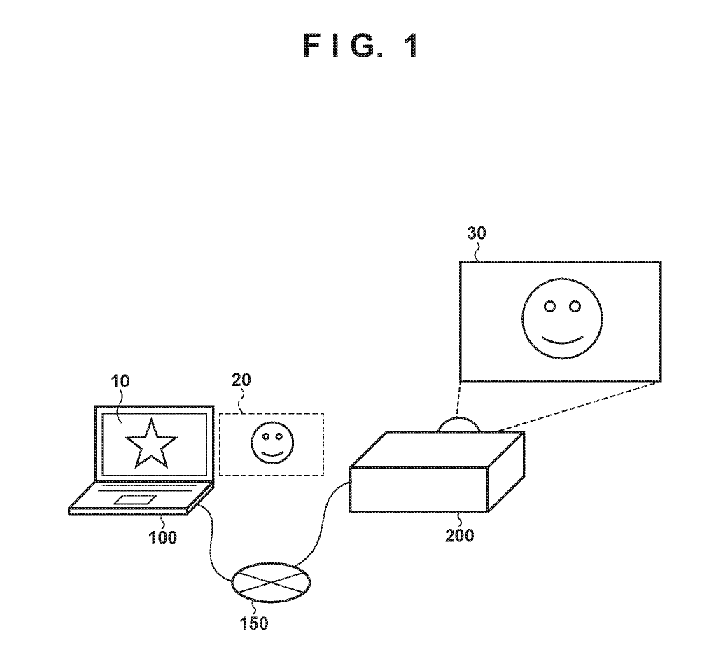

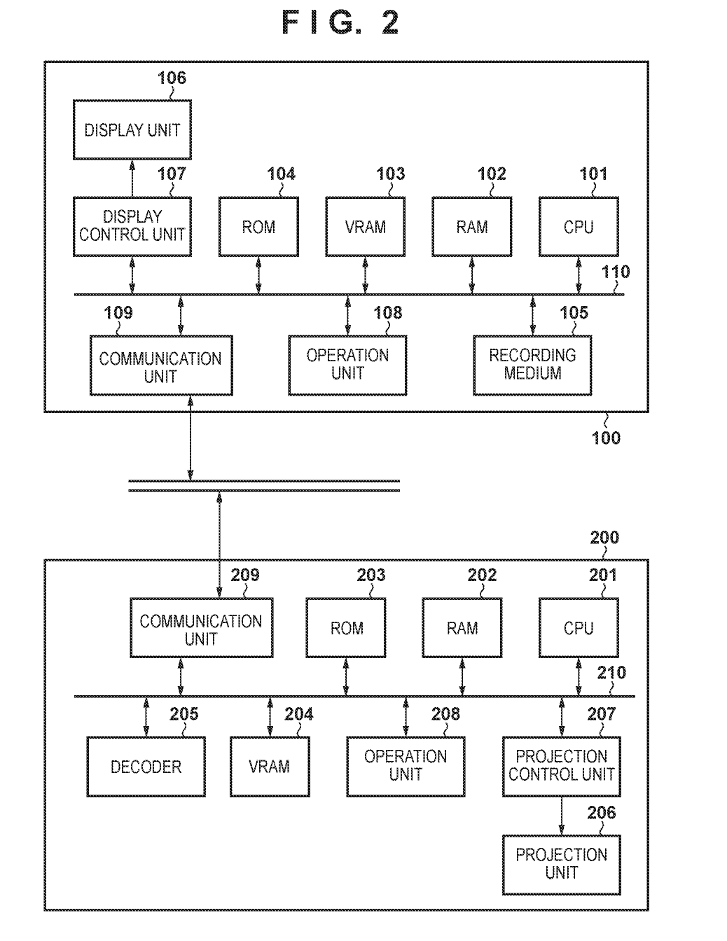

A video image transfer system according to a first embodiment will be described hereinafter with reference to FIGS. 1 and 2.

In the present embodiment, while a case in which a PC is used as an exemplary information processing apparatus and a projector is used as an exemplary video image display apparatus, the present invention is not limited to this. For example, a mobile phone, a digital camera, or a so-called tablet terminal may be used as the information processing apparatus of the present invention. Furthermore, a display, a digital TV set, or a so-called tablet terminal may be used as the video image display apparatus of the present invention. Also, for example, any other type of display apparatus that can display video images transferred from a PC may be used as the video image display apparatus.

In FIG. 1, a PC 100 and a projector 200 of the present embodiment are connected via a communication network 150 such as a LAN (Local Area Network). Upon establishing communication between the PC 100 and the projector 200, the PC 100 generates, in addition to a video image 10 on the main display, a video image 20 of an extended display and transfers the video image as a video image 30 that is compatible with the resolution of the projector 200. The projector 200 projects the video image 30 of the extended display transferred from the PC 100 onto a screen, etc. In this way, the user operating the PC 100 (the presenter) can display, using the projector 200, the presentation video image 30 intended for an audience while, displaying on the PC 100, the video image 10 which could be supplemental materials for the presenter, that is different from the video image 30.

As used in the present embodiment, the term “extended display” refers to an area outside of the range of the main display of the PC 100 that is created when the desktop UI displayed on the main display of the PC 100 is extended exceeding the main display resolution of the PC 100. Referring to FIG. 1 as an example, the main display of the PC 100 displays the video image as indicated by the reference numeral 10, and the desktop area, while not being shown on the main display, is connected to the right side of the main display as indicated by the reference numeral 20. This area 20 is referred to as the extended display (virtual display).

Referring now to FIG. 2, the configurations of the PC 100 and the projector 200, which constitute the video image transfer system of the present embodiment, will be described hereinafter.

First, the configuration and function of the PC 100 will be described hereinafter.

The CPU 101 performs overall control of the PC 100, such as display control, recording control, video image processing control, communication control, by controlling its components according to input signals and programs. A RAM 102 is the main memory for storing data. The RAM 102 is mainly used as an area for storing various types of data, such as an area for storing or deploying programs executed by the CPU 101 or a work memory for programs being executed. A VRAM 103 stores video image data displayed on a display unit 106. If the RAM 102 is sufficiently fast, the RAM 102 may be used as the VRAM 103. A ROM 104 stores the boot program that is executed when the CPU 101 is initialized. The boot program deploys and starts, on the RAM 102, the OS (Operating System) stored in the recording medium 105. The recording medium 105 is a memory card or a hard disk drive for storing data and various programs, such as the video image transfer program described below and the OS.

The display unit 106 displays the video image data specified by a display control unit 107. The display unit 106, for example, is a liquid crystal panel or an organic EL panel. The display control unit 107 reads out the video image data stored in the VRAM 103 and displays it on the display unit 106. An operation unit 108 comprises operation members, such as a keyboard, a mouse, and a touch panel, to accept input made by a user and transmit the input to the CPU 101. If a touch panel is used, the touch panel is provided integrated with the display unit 106 so that operations can be input by touching the display surface. A communication unit 109 communicates with external apparatuses, such as the projector 200, via the communication network 150. The communication unit 109 is a communication interface module, such as a Gigabit Ethernet (r) or wireless LAN module. The communication unit 109 is, however, not limited to these, and various communication systems can also be used. An internal bus 110 connects the above-described components, The PC 100 may not necessarily be controlled by a single piece of hardware. For example, a plurality of pieces of hardware may share the load of processing to implement the various functions of the PC 100.

The following describes basic operations of the PC 100 of the present embodiment.

An application program for transferring video images (to be referred to as the video image transfer program hereinafter) is installed in the PC 100. The video image transfer program executed by the CPU 101 controls the display control unit 107 and captures the video image data displayed on the display unit 106 from the VRAM 103, and encodes it in a predetermined format (for example, JPEG) that the projector 200 is capable of projecting. The video image transfer program executed by the CPU 101 transmits the encoded video image data to the projector 200 via the communication unit 109. The video image transfer program executed by the CPU 101 accepts various types of operations such as selection of the projector to be connected to and starting/stopping of video image data transfer, via the GUI provided by the video image transfer program. The video image transfer program converts such operations into control commands and transmits the commands to the projector 200 via the communication unit 109.

Next, the configuration and functions of the projector 200 will be described hereinafter.

The functions of a CPU 201, a RAM 202, a ROM 203, a VRAM 204, an operation unit 208, a communication unit 209, and an internal bus 210 as hardware are the same as those in the PC 100, description of these components is omitted.

The ROM 203 stores the programs and parameters required for the projector 200 to operate, and the CPU 201 operates according to the programs stored in the ROM 203. The VRAM 204 stores the video image data projected by the projection unit 206. The decoder 205 decodes the encoded video image data transferred from the PC 100. The projection unit 206 has a liquid crystal panel, a lens, a light source, etc., to project the decoded video image. The projection control unit 207 reads out the video image data held in the VRAM 204 and causes the projection unit 206 to project the data. Alternatively, the CPU 201 may operate as the projection control unit 207. The projector 200 may not necessarily be controlled only by the above-described hardware. For example, a plurality of pieces of hardware may share the load of processing to implement the various functions of the PC 100.

The operation unit 208 comprises buttons provided on the main body of the apparatus and a remote controller reception unit for accepting user operations from a remote controller (not shown) and transmitting them to the CPU 201.

The following describes basic operations of the projector 200 of the video image transfer system of the present embodiment.

The CPU 201 of the projector 200 receives, via the communication unit 209, the encoded video image data transferred from the PC 100, decodes the data using the decoder 205, and deploys the decoded data on the VRAM 204. The CPU 201 also controls the projection control unit 207, reads out the video image data deployed on the VRAM 204, and projects the data using the projection unit 206. Additionally, if the projector 200 is selected as the projector to be connected to in the PC 100, the CPU 201 receives control commands from the PC 100 via the communication unit 209, such as a connection request and starting/stopping of video image data transfer, and executes processing according to the commands received.

Description of System Operation

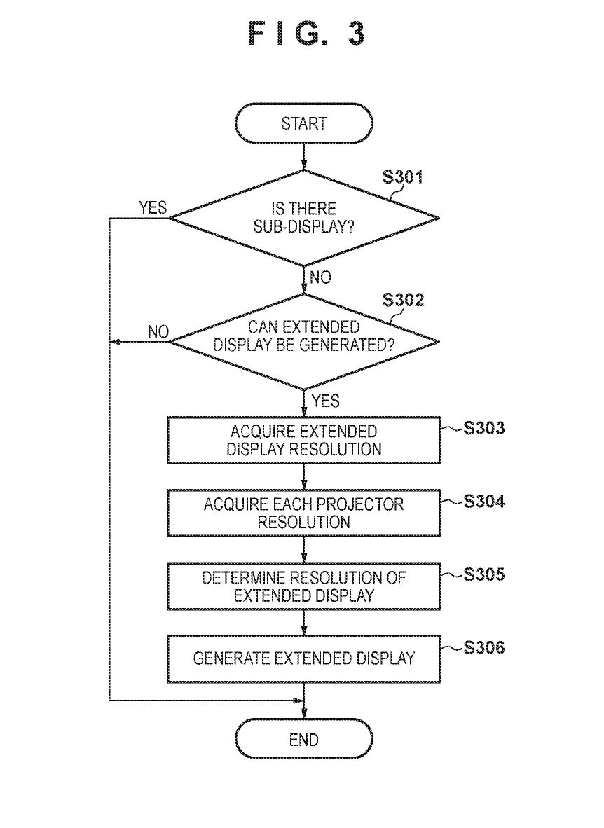

Next, the operations of a system according to the present embodiment will be described with reference to FIGS. 3, 4, 5A to 5L and 6A to 6C.

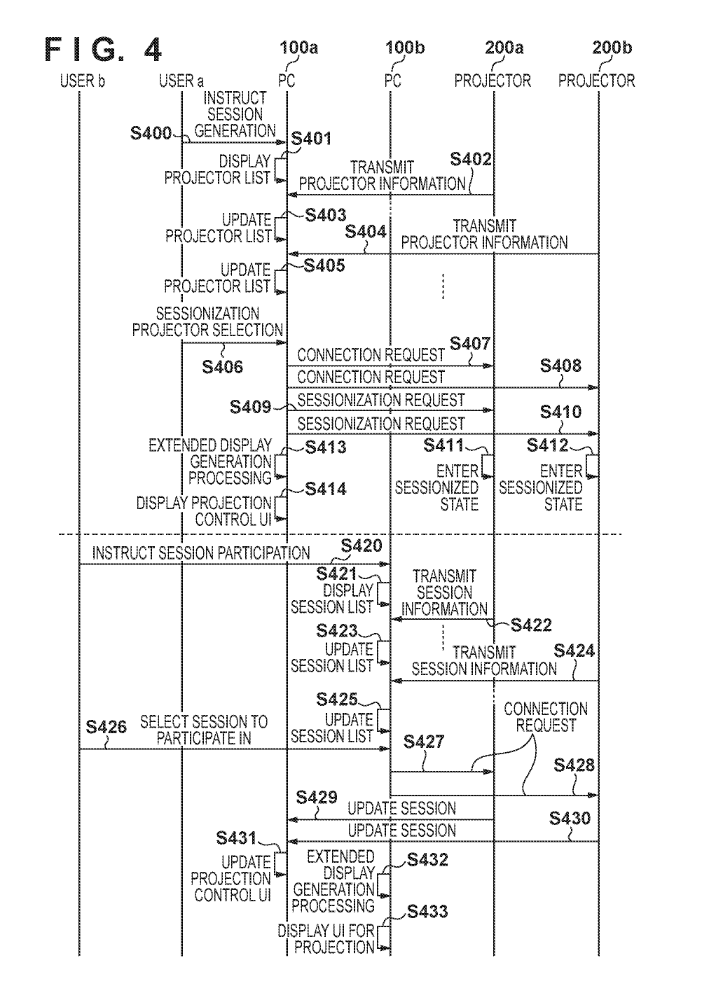

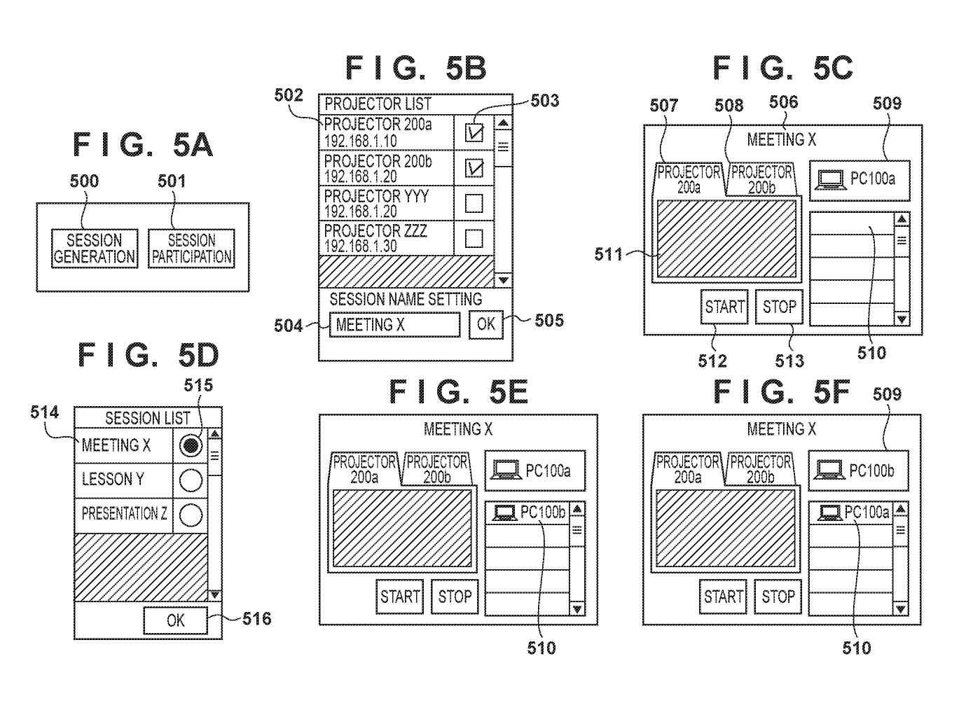

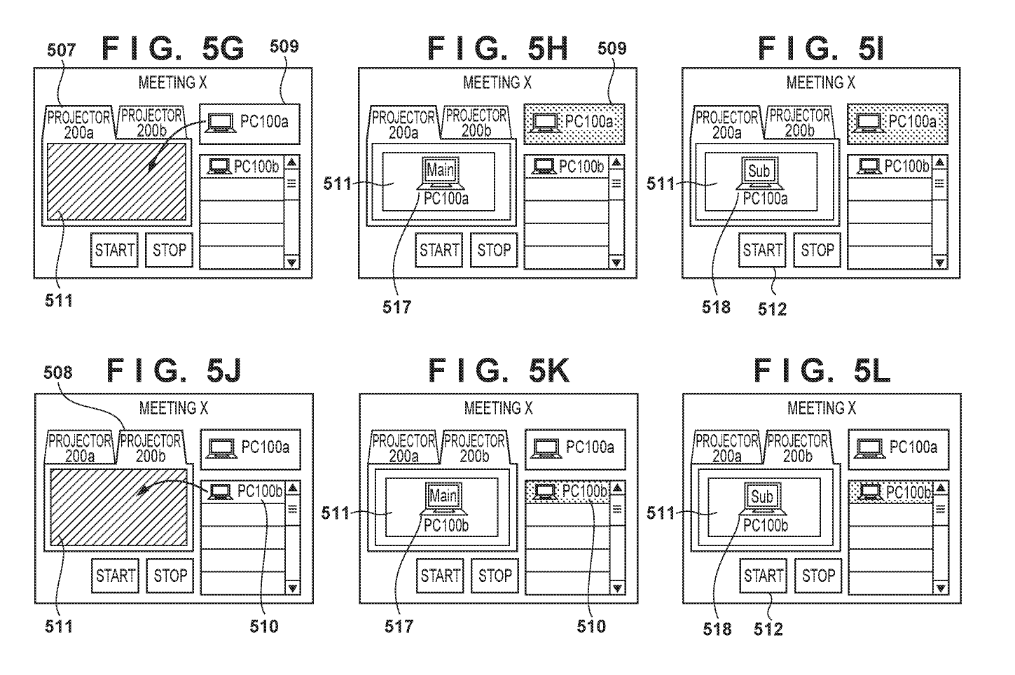

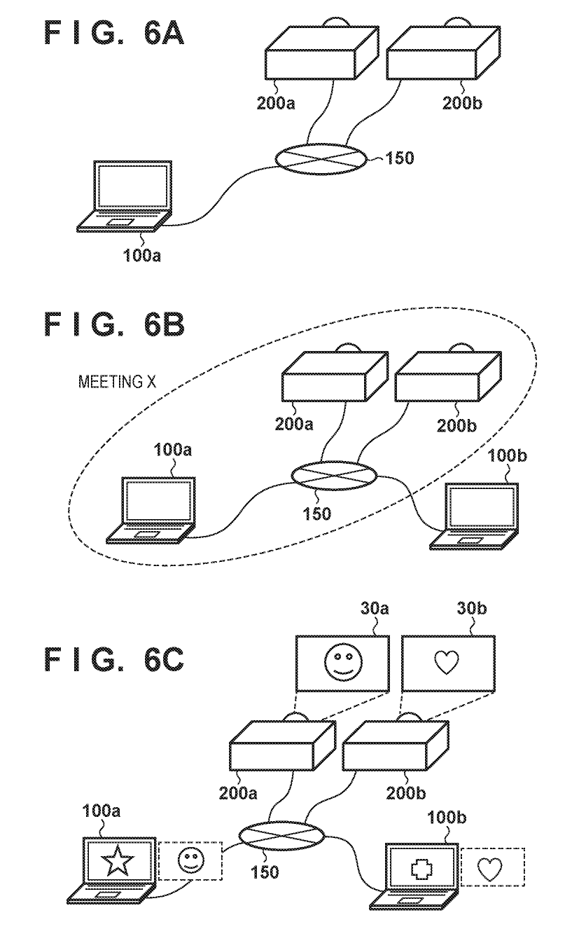

FIG. 3 shows a procedure followed by the PC 100 to generate an extended display. FIG. 4 is a sequence diagram showing the processing performed by the user, the PC, and the projector. FIGS. 5A to 5L show exemplary UI screens of the video image transfer program of the PC. FIGS. 6A and 6C show alternative system configurations.

The following describes the processing to generate an extended display in the cases shown in FIGS. 6A and 6B. FIG. 6A shows a case in which the video image transfer program of the PC 100a generates a group consisting of projectors 200a and 200b (referred to as a session hereinafter). FIG. 6B shows a case in which a new PC 100b participates in an already generated session (a Meeting X). Although not described in detail, a logical connection has been established between all of the PCs and all of the projectors involved in a session. This makes it possible to start and stop the transfer of video image data via the network to each of the projectors selected via the video image transfer program of the PC 100a. This also makes it possible to simultaneously transmit the screens of the PCs to all the projectors generating a session. It is also possible for one PC to instruct another PC to start and stop the transfer of video image data.

Description of Session Generation Sequence

First, the sequence in which the video image transfer program of the PC 100a is operated to generate a session formed by the projectors 200a and 200b will be described with reference to FIGS. 4 and 5A to 5L. The following description refers to a user operating the PC 100a as a user A.

When the user A activates the video image transfer program of the PC 100a, the UI shown in FIG. 5A is displayed to prompt the user to select whether generate a session or participate in a session that has already been generated.

In step S400, the user A instructs the video image transfer program of the PC 100a to generate a new session. In other words, the user A presses a button 500 shown in FIG. 5A.

In step S401, the video image transfer program of the PC 100a displays the list of projectors shown in FIG. 5B for selecting projectors to generate a session with. The projector list includes a projector information command to be broadcast by the projectors via the network.

In the present embodiment, the projectors 200a and 200b are on the network, and thus the projectors 200a and 200b broadcast a projector information command over the network in steps S402 and S404. A projector information command includes the IP address of the projector and the projector name, for example. In this example, to simplify the description, a projector information command is transmitted when an instruction to generate a session is made. However, before being sessionized, each projector transmits a projector information command at regular intervals.

In steps S403 and S405, the video image transfer program of the PC 100a updates the projector list because projector information commands have been received. In particular, as shown in FIG. 5B, information regarding the projectors 200a and 200b is displayed in a projector list display area 502 as projectors that can be selected when generating a session. The UI shown in FIG. 5B displays a list of pieces of information regarding the projectors that can be selected for sessionization and includes check boxes 503 for selecting the projectors.

In step S406, the user A selects the projectors 200a and 200b from the projector list of the video image transfer program of the PC 100a to issue an instruction to generate a session. This operation corresponds to the selection of the projectors 200a and 200b made by checking the appropriate check boxes 503 shown in FIG. 5B. This also corresponds to entering the name of the session to a session name entry area 504 (“Meeting X” in this example) and pressing a confirmation button 505.

In steps S407 and S408, the video image transfer program of the PC 100a establishes a logical connection with the projectors 200a and 200b, which are to be sessionized, and the PC 100a. Upon establishing a connection, the PC 100a transmits its own IP address and name (“PC 100a” in this example) to the projectors 200a and 200b. As described above, data transfer is enabled between the PC that has established a connection and the sessionized projectors. Although a detailed description is omitted, password verification may additionally be required for each projector before establishing a connection.

In steps S409 and S410, the video image transfer program of the PC 100a transmits a sessionization request command to each of the projectors 200a and 200b, with which a connection has been established. A sessionization request command includes at least the number of projectors selected from the projector list display area 502 of FIG. 5B with which a session is generated and information regarding each projector (the IP address and the projector name). Furthermore, the sessionization request command includes the session name entered in the session name entry area 504 shown in FIG. 5B.

In steps S411 and S412, upon receiving a sessionization request command, the projectors 200a and 200b enter a sessionized state. In these steps, the CPU 201 of each of the projectors 200a and 200b stores, in the RAM 202, information regarding each projector (the IP address and the projector name), the name of the session, and information regarding the PC participating in the session (the IP address and the PC name).

In step S413, the video image transfer program of the PC 100a performs the processing to generate an extended display, which will be described below.

Extended Display Generation Processing

Referring now to FIG. 3, the processing performed in step S413 of FIG. 4 to generate an extended display will be described hereinafter. The processing shown in FIG. 3 is implemented by the CPU 101 of the PC 100 executing the video image transfer program.

In step S301, the CPU 101 uses the display control unit 107 to determine whether or not a sub-display exists in addition to the main display. If a sub-display exists, the processing is terminated, and if there is no sub-display, the process proceeds to step S302. If a sub-display exists in the setup, it is possible, for example, to display presentation materials to the audience on the main display while displaying auxiliary materials to the presenter on the sub-display. In other words, without applying the present embodiment, the user can cause the projector to project the presentation materials and cause the display at hand to display the auxiliary materials simply by specifying that the main display is to be transferred to the projector.

In step S302, the CPU 101 determines, via the display control unit 107, whether or not it is possible to generate an extended display. If it is possible to generate an extended display, the process proceeds to step S303, otherwise the process is terminated. In this example, the display control unit 107 is already controlling the display operation of the display unit 106. In this processing, in addition to causing the display unit 106 (the main display) to display information, the video image transfer program also makes an inquiry to the display driver as to whether or not it is possible to generate an extended display via the API (Application Programming Interface) provided by the OS.

In step S303, the CPU 101 acquires the resolution corresponding to the extended display from the display control unit 107 and stores it in the RAM 102, and the process proceeds to step S304.

In step S304, the CPU 101 controls the communication unit 109 to request each of the projectors with which connection has been established to transmit its resolution, and stores the resolution received from each projector in the RAM 102, and the process proceeds to step S305.

In step S305, the CPU 101 determines the resolution of the extended display based on the resolution corresponding to the extended display stored in the RAM 102 in step S303 and the resolutions of the connected projectors stored in the RAM 102 in step S304, and the process proceeds to step S306. In this case, as the resolution at which the extended display can be generated, the CPU 101 applies, for example, the resolution closest to the lowest resolution of the resolutions of the plurality of connected projectors (including the resolution equivalent to the smallest resolution). In this way, the network bandwidth can be minimized when simultaneously displaying the video image of the extended display using all of the plurality of the connected projectors. In addition, as the video image received by the projectors need not be reduced, it is possible to reduce character blurring and the like.

Alternatively, as the resolution at which the extended display can be generated, the CPU 101 may apply, for example, the resolution closest to the largest resolution of the resolutions of the plurality of connected projectors (including the resolution equivalent to the largest resolution). As this allows for transfer of an optimum video image for the projector that has the highest resolution of the resolutions of the plurality of connected projectors, the optimized projector is capable of projecting the video image at high resolution.

In step S306, the CPU 101 instructs the display control unit 107 to generate an extended display at the resolution determined at step S305, and the extended display is generated.

Continued Description of Session Generation Sequence

Returning to FIG. 4, the description of the sequence in which a session is generated is resumed. To simplify the following description, in this example, the PC 100a is determined as being able to generate an extended display in step S302, and an extended display has been already generated.

In step S414, the video image transfer program of the PC 100a displays the projection control UI shown in FIG. 5C to control the projection operations of the sessionized projectors.

The projection control UI includes a session name display area 506, sessionized projector selection tabs 507 and 508, an own PC information display area 509 that shows information regarding the PC that is executing this particular video image transfer program, and a separate PC information display area 510. In addition, the projection control UI includes a projection layout setting area 511, a projection start button 512, and a projection stop button 513.

In the present embodiment, as the PC 100a has sessionized the projectors 200a and 200b under the session name of “Meeting X,” the two sessionized projector selection tabs 507 and 508 are displayed. By selecting the tab 507 or 508, the user can display and control the projection layout setting area 511 of the projector that corresponds to the selected tab. A tab is displayed for each sessionized projector. As this session is named “Meeting X”, this session name is displayed in the session name display area 506. The own PC information display area 509 displays information regarding the PC itself that is currently executing the video image transfer program (that is, information regarding the PC 100a). The separate PC information display area 510 displays information regarding PCs belonging to a session other than the own PC. However, as this step of the present example comes immediately after the generation of a session, nothing is shown in this area as there are no other participating PCs.

Description of Session Participation Sequence

Next, as shown in FIG. 6B, the sequence in which the video image transfer program of the PC 100b participates in the session generated by the PC 100a to which the projectors 200a and 200b belong will be described with reference to FIGS. 4 and 5A to 5L. In the following description, the user who operates the PC 100b is referred to as the user B.

First, When the user B activates the video image transfer program of PC 100b, the UI shown in FIG. 5A is displayed to prompt the user to select whether to generate a session or participate in a session that has already been generated. In step S420, the user B instructs the video image transfer program of the PC 100b to participate in a session. In other words, the user A presses a button 501 shown in FIG. 5A.

In step S421, the video image transfer program of the PC 100b displays the session list shown in FIG. 5D for selecting the session to participate in. The session list includes a session information command to be broadcasted by the projectors via the network.

In the present embodiment, the projectors 200a and 200b are sessionized on the network in steps S411 and S412. Therefore, in steps S422 and S424, each of the projectors 200a and 200b reads session information from the RAM 202 and broadcasts it over the network as a session information command. A session information command includes the number of projectors generating the session, the IP address of each projector, the name of each projector, the session name, the IP addresses of the PCs, and the names of the PCs. In addition, the aforementioned information is included in the information transmitted to the projectors 200a and 200b upon the PC 100a making a connection request in steps S407 and S408 and in the sessionization request command transmitted by the PC 100a in steps S409 and S410. As the information transmitted by the PC 100a to the projector 200a is the same as the information transmitted by the PC 100a to the projector 200b, the session information commands transmitted by the projectors 200a and 200b are also the same. The projectors to be sessionized are the two projectors 200a and 200b, the session name is “Meeting X”, and the PC that is participating in the session is the PC 100a.

The video image transfer program of the PC 100b has received session information commands, and thus the program updates the session list in steps S423 and S425. Specifically, the session list display area 514 indicates the session name “Meeting X” as the session to participate in as shown in FIG. 5D. As the session information commands received in steps S423 and S425 are the same, no update is performed in step S425. The session list is provided with a radio button 515 for selecting a session to participate in, allowing the user to select one session to participate in.

In step S426, from the session list of the video image transfer program of the PC 100b, the user B selects the session to which the projectors 200a and 200b belong as the session to participate in. This operation corresponds to selecting “Meeting X” using the radio button 515 shown in FIG. 5D and pressing an OK button 516.

In steps S427 and S428, the video image transfer program of the PC 100b establishes a logical connection with the projectors 200a and 200b to be sessionized and the PC 100b. The PC 100b transmits its own IP address and name (“PC 100b” in this example) to the projectors 200a and 200b.

In steps S429 and S430, the projectors 200a and 200b connected to the new PC 100b update the PC information regarding the PC that is already participating in the session, the PC information being managed as session information, and also notify the PC that is participating in the session (the PC 100a) of this fact.

In step S431, the video image transfer program of the PC that has received the notification made in step S430 (the PC 100a) updates the projection control UI as shown in FIG. 5E based on the received session information. As the session information includes the name of the PC 100b, which has newly participated in the session, the video image transfer program of the PC 100b updates the separate PC information display area 510 to show information regarding the PC 100b.

In step S432, the video image transfer program of the PC 100 performs the processing to generate an extended display as described in connection with step S413 in FIG. 4.

In step S433, the video image transfer program of the PC 100b shows the projection control UI shown in FIG. 5F to control the projection operations of the sessionized projectors. The content in the own PC information display area 509 and the content in the separate PC information display area 510 of the UI shown in FIG. 5F are the reverse of those in the UI of the video image transfer program of the PC 100a shown in FIG. 5E.

Projection Control After Sessionization

With reference to FIGS. 5E to 5L. the following describes the procedure in which after sessionization the user transfers, via the projection control UI of the video image transfer program of the PC 100a, the video image of the extended display of the PC 100a to the projector 200a and the video image of the extended display of the PC 100b to the projector 200b as shown in FIG. 6C.

Transfer of Extended Display Generated by PC 100a to Projector 200a

First, the procedure by which the video image transfer program of the PC 100a transfers the video image of the extended display generated by the PC 100a to the projector 200a will be described hereinafter.

As a result of the processing described so far, the projection control UI of the video image transfer program of the PC 100a is as shown in FIG. 5E. In this state, the tab 507 is selected from the sessionized projector tabs, as shown in FIG. 5G, in order to operate the projection layout of the projector 200a. Moreover, in FIG. 5G, when the own PC information display area 509 indicating the PC 100a is dragged and dropped in the projection layout setting area 511, the projection control UI changes to that shown in FIG. 5H. The own PC information display area 509 is grayed out to indicate the own PC is in the projection layout. Furthermore, the projection layout setting area 511 indicates, with the icon 517, that the display to be projected of the PC 100a, or the own PC, is the main display. By clicking on the icon 517, the projection control UI changes to that shown in FIG. 5I.

In this way, the display to be projected can be switched to the sub-display as indicated by the icon 518 as shown in FIG. 5I. In the PC 100a, the extended display generated in step S413 of FIG. 4 is the display to be projected. It should be noted that, if it is determined in step S301 of FIG. 3 that a sub-display exists, the sub-display is the display to be projected.

By pressing the projection start button 512 in this state, the video image transfer program of the PC 100a controls the display control unit 107 to capture the video image data that corresponds to the extended display from the VRAM 103 and encode the data. Subsequently, the encoded video image is transmitted via the communication unit 109 to the projector 200a (selected in step S407 of FIG. 4), which in turn receives, decodes, and projects the video image as described above. As a result, as shown in FIG. 6C, the projector 200a projects the extended display 30a of the PC 100a.

Transfer by PC 100a of Extended Display Generated by Other PC (PC 100b) to Projector 200b

The following describes the procedure in which the video image transfer program of the PC 100a transfers the video image of the extended display generated by the PC 100b to the projector 200b.

The tab 508 shown in FIG. 5J is selected, from among the sessionized projector tabs in the state shown in FIG. 5I, in order to operate the projection layout of the projector 200b. At this point, as projection layout has not vet been set for the projector 200b, no settings have been made in the projection layout setting area 511 as shown in FIG. 5J. Moreover, in FIG. 5J, when the separate PC information display area 510 showing the PC 100b is dragged and dropped in the projection layout setting area 511, the projection control UI changes to that shown in FIG. 5K. The separate PC information display area 510 is grayed out to indicate the PC 100b, which is the separate PC, is already in the projection layout. Furthermore, the projection layout setting area 511 indicates, with the icon 517, that the display of the PC 100b to be projected is the main display. By clicking on the icon 517, the projection control UI changes to that shown in FIG. 5L.

In this way, the display to be projected can be switched to the sub-display as indicated with the icon 518 shown in FIG. 5L. As an extended display was generated in the PC 100b in step S432 of FIG. 4, the extended display is the display to be projected. It should be noted that, if it is determined in step S301 of FIG. 3 that a sub-display exists, the sub-display will be the display to be projected.

By pressing the projection start button 512 in this state, the video image transfer program of the PC 100a transmits a layout notification of the fact that the extended display of the PC 100b is to be projected, to the projector 200b via the communication unit 109. Upon receiving this layout notification, the CPU 201 of the projector 200b reads out the information regarding the PC 100b from the session information managed by the RAM 202 and transmits, to the IP address of the PC 100b, a transmission start request to start transmission of the extended display video image.

Upon receiving the request to start transmission of the extended display video image, the video image transfer program of the PC 100b controls the display control unit 107 to capture the video image data that corresponds to the extended display from the VRAM 103 and encode the data. Subsequently, the encoded video image is transmitted via the communication unit 109 to the projector 200b (i.e., the source of the request to start transmission of the extended display video image), which in turn receives, decodes, and projects the video image as described above. As a result, as shown in FIG. 6C, the projector 200b projects the extended display 30b of the PC 100b.

In the foregoing embodiment, to simplify the description, a technique has been described in which the video image transfer program of the PC 100a is used to control projection. It should be noted, however, that the video image transfer program of the PC 100b is capable of performing the same control. The same applies if more PCs participate in the session.

Although not shown in FIG. 3, when user operation is made instructing termination of the video image transfer program, the CPU 101 may show a UI for selecting whether to leave the session in which the user is participating or to terminate the session in which the user is participating.

If the user issues an instruction to leave the session in which the user is participating, that is, if the connection with the projectors with which this PC is logically connected is interrupted, the display control unit 107 may be controlled to discard the extended display generated in step S306.

If the user issues an instruction to terminate the session in which the user is participating, the connection with the projectors with which this PC is logically connected may also be interrupted and the extended display may be discarded as described above. Moreover, if an instruction to terminate a session is issued, the other PC that is participating in the session also detects the termination of the session. In this case, the logical connection with the projectors may also be interrupted and the extended display may also be discarded.

Also, in addition to the normal processing flow described above, the video image transfer program may also interrupt a logical connection with the projectors and discard extended displays if it is detected that it is no longer possible to communicate with any of the projectors forming the session.

To confirm that communication with the projectors is valid, the video image transfer program may use, for example, the projector information command transmitted at regular intervals described in connection with steps S402 and S404 of FIG. 4. That is, if it is detected that a projector information command has not been received from any of the projectors forming the session for a predetermined period of time, the video image transfer program can determine that communication with that projector has ceased.

As described above, in the video image transfer system of the present embodiment, extended displays of PCs can be transferred to projectors after sessionization.

An extended display can be invalidated when a user leaves the session, when a session is terminated, when termination of a session is detected, or upon detecting that the communication path to a projector forming the session has been cut off. Furthermore, as a PC generates an extended display using the display driver that controls the main display, a display different from the main display can be generated and transferred without installing a virtual display driver. A virtual display driver cannot be installed to a PC if the version of Windows is Windows Vista or later. If the video image transfer program of the present embodiment is used, however, an extended display (a virtual display) can be generated at the PC and transferred to projectors.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-231928, filed Dec. 1, 2017 which is hereby incorporated by reference herein in its entirety.

What is claimed is:

1. An information processing apparatus which displays a video image on a display unit, comprising:
a communication unit configured to communicate with a display apparatus via a network; and
a control unit configured to generate a video image of an extended display to be displayed on the display apparatus when the communication unit establishes a connection with the display apparatus, the video image being different from the video image displayed on the display unit.

2. The apparatus according to claim 1, wherein the control unit does not generate the video image of the extended display if a plurality of display units provided.

3. The apparatus according to claim 1, wherein the control unit receives the resolution of the display apparatus from the display apparatus when the communication unit establishes a connection with the display apparatus.

4. The apparatus according to claim 1, wherein the control unit determines the resolution of the video image of the extended display based on the resolution of the display apparatus and the resolution of video images that the control unit is able to generate.

5. The apparatus according to claim 4, further comprising a plurality of display apparatuses;
wherein the control unit determines the resolution of the video image of the extended display based on the resolutions of the plurality of display apparatuses and the resolution of video images that the control unit is able to generate.

6. The apparatus according to claim 5, wherein the control unit applies, as the resolution of the video image of the extended display, the resolution closest to the smallest resolution of the resolutions of the plurality of display apparatuses, from among the resolutions at which the control unit is able to generate video images.

7. The apparatus according to claim 5, wherein the control unit applies, as the resolution of the video image of the extended display, the resolution closest to the largest resolution of the resolutions of the plurality of display apparatuses, from among the resolutions at which the control unit is able to generate video images.

8. The apparatus according to claim 1, wherein the control unit discards the video image of the extended display if a connection with the display apparatus is interrupted.

9. The apparatus according to claim 5, wherein, if a new information processing apparatus participates in a group to which the plurality of display apparatuses belong and with which a connection is established by the communication unit, the control unit transfers a video image of an extended display generated at the new information processing apparatus to at least one of the plurality of display apparatuses.

10. The apparatus according to claim 1, wherein the control unit captures and transmits the video image of the extended display to the display apparatus.

11. A method of controlling an information processing apparatus that includes a communication unit configured to communicate with a display apparatus via a network and display a video image on a display unit, the method comprising:
generating a video image of an extended display to be displayed on the display apparatus displays when the communication unit establishes a connection with the display apparatus, the video image being different from the video image displayed on the display unit.

12. A non-transitory computer-readable storage medium storing a program for causing a computer to execute a method of controlling an information processing apparatus that includes a communication unit configured to communicate with a display apparatus via a network and display a video image on a display unit, the method comprising:
generating a video image of an extended display to be displayed on the display apparatus displays when the communication unit establishes a connection with the display apparatus, the video image being different from the video image displayed on the display unit.
